(19) United States
(12) Patent Application Publication
(10) Pub. No.: US 2019/0235117 A1
(43) Pub. Date: Aug. 1, 2019

(54) POSITIONING OF SEISMIC EQUIPMENT IN A TOWED MARINE ARRAY

(71) Applicant: POLARCUS DMCC, Dubai (AE)

(72) Inventors: Erik GODØY, Nesbru (NO); Gary WINFIELD, Dubai (AE)

(73) Assignee: POLARCUS DMCC, Dubai (AE)

(21) Appl. No.: 16/326,401

(22) PCT Filed: Oct. 2, 2017
(86) PCT No.: PCT/NO2017/050257

§ 371 Date: Feb. 19, 2019

(30) Foreign Application Priority Data
Oct. 19, 2016 (NO) 20161662

(51) Int. Cl. G01V 1/38; G01V 1/00; G01V 1/20

(52) U.S. Cl. CPC G01V 1/3835; G01V 1/3826; G01V 1/20; G01V 1/006

(57) ABSTRACT

A positioning system (100) for marine seismic surveying, comprising a towing vessel (110), a source array (120) and a receiver array (130) with several streamers (131). Each streamer (131) comprises at least three birds (134) and positioning sensors (134-137) wherein several seismic receivers (132) are placed between each pair of birds (134). The system (100) comprises a dynamic model wherein each streamer (131) is represented by a fitted B-spline curve and each bird (134) is associated with a constant velocity and a constant acceleration; and a Kalman filter using the dynamic model and observations from the positioning sensors (134-137) to provide a geodetic position of each seismic receiver (132) with better accuracy than the dynamic model alone and observations alone within a time interval Δt equal to or less than a minimum time between shots determined by the source array (120).

### BACKGROUND

### Field of the Invention

The present invention concerns a system and method for a seismic survey using towed streamers.

### Prior and Related Art

In a marine seismic survey, one or more surface vessel tows a source array and a receiver array comprising several streamers below a sea surface. The seismic sources emit powerful acoustic pulses, shots, which penetrate into an underground formation. Interfaces between materials with different elastic properties reflect and refract the waves, and seismic receivers in the receiver array record the echoes for later geophysical analysis. Seismic waves comprise P-waves and S-waves, but S-waves do no travel through fluids, so only P-waves are recorded in a marine seismic survey.

From an operational view, the seismic data acquisition should cover a large area per unit time and in particular reduce or eliminate needs for costly infills. From a geophysical view, the ultimate purpose of a survey is to provide proper boundary conditions for seismic equations, specifically to emit a series of pulses and sample a P-wavefield at discrete points in time and space. Improved temporal and spatial resolution of the sampling improves the quality of the geophysical model. General technological progress has increased common shot rates toward one shot per 5 seconds and reduced bin sizes from 25 toward 6.25 m². Similarly, the number of streamers in an array have increased from a few to 12-18, present streamer lengths are up to 10 or 20 km and a typical inline spacing between receivers is 12.5 m, so there are currently 10-30 000 seismic receivers per array.

Thus, there is a need for a robust positioning system able to provide accurate geodetic positions for sources and receivers. Specifically, the bin size 6.25 m² sets 12.5 m as upper limit for position of source with respect to receiver, so the system should provide at least 30 000 geodetic positions to within a few meters every 5 seconds or less.

U.S. Pat. No. 4,868,793 A (Dunbar/Atlantic Richfield) discloses a system and method where several laterally spaced subarrays are fired simultaneously and constitute one seismic source. Several such sources are fired sequentially in a round robin scheme. Firing several subarrays at the same time releases more acoustic energy per shot than firing one subarray per shot. The increased energy improves the signal to noise ratio (SNR) of the received waves. Accordingly, the minimum number of subarrays and number of airguns per source can be determined by a desired SNR. The period of the round-robin scheme must be larger than a maximum charge time required to charge a subarray, such that every subarray may be fired during each cycle. Thus, the source array may be divided into n sources, the period T may be divided into T/n intervals, and a source may be fired at the end of each interval. For example, a charging time T of 10 seconds and two sources may yield a shot with sufficient acoustic energy for an acceptable SNR at most every 5 seconds.

The receiver array comprises several streamers, their leading ends typically spread laterally from the towing direction by paravanes. Each streamer also carry birds able to exert a force on the streamer lateral to the towing direction and/or vertically. A tail buoy, also called a float, may be attached to the trailing end of a streamer. The streamer may also comprise position sensors and other equipment briefly described with reference to FIGS. 1 and 2. We will use the terms loosely defined above throughout the following description and claims. We will also distinguish between “feathering”, which is caused by sea currents and “fanning”, which is a streamer configuration intended to cover a wider area during a pass.

U.S. Pat. No. 4,798,156 A (Langeland et al./Geco) discloses a streamer array with variable distances between the leading ends of streamers in an array, cf. FIG. 3.

AU 661000B2 (Marschall/Prakla) discloses a method for marine seismic data acquisition in which at least one streamer is guided with its longitudinal axis parallel to the line of course and a plurality of additional streamers deployed on either side of the line of course in a fan arrangement. Thereby, each pass over a survey area covers a wider area.

U.S. Pat. No. 6,691,038 B2 (Zajac/WesternGeco) discloses a seismic streamer array tracking and positioning system comprising a towing vessel for towing a seismic array and an array comprising a plurality of seismic streamers. An active streamer positioning device (ASPD) is attached to at least one seismic streamer for positioning the seismic streamer relative to other seismic streamers within the array. A master controller is provided for issuing positioning commands to each ASPD to adjust a vertical and horizontal position of a first streamer relative to a second streamer within the array for maintaining a specified array geometry. The system accounts for environmental factors. Zajac describes different receiver arrays, including one with streamers at different depths to improve temporal resolution.

U.S. Pat. No. 7,944,774 B2 (Monk et al./Apache Corporation) discloses a method for determining adequacy of seismic data coverage of a subsurface area being surveyed and its application to selecting sensor array geometry. A data trace is created for each of the detected signals. At least one Fresnel zone is determined for at least some of the seismic data traces. A contribution of each of the traces to each one of a plurality of bins defined in a predetermined pattern is computed based on the Fresnel zone associated with each trace. Based on the computed contributions, a maximum lateral distance between corresponding seismic sensors is determined that will result in a contribution sum above a selected threshold. The streamers may be fanned.

US 20140269168 A (Hillesund et al./PGS Geophysical) discloses a control system for a streamer array in which input from position devices along the streamers are used to calculate a new desired orientation. The new desired orientation may include a new desired feather angle for the streamer. This “desired feather angle” includes a “fanning angle” in our terminology. Hillesund is also co-inventor in several patent publications from the last few decades, e.g. WO0020895A and U.S. Pat. No. 7,080,607 B2.

U.S. Pat. No. 8,897,094 (Eick et al./Conoco Phillips) discloses a streamer array where the spacing between leading ends of adjacent streamers vary with at least 5% and the outermost streamers have a fan angle of at least 2.5% each.

A general objective of the present invention is to solve or alleviate at least one of the problems above. Specific objects include providing accurate geodetic positions for all seismic sources and receivers in each shot interval and providing a graphical user interface (GUI) for specifying a predefined or ad hoc streamer configuration.

### SUMMARY OF THE INVENTION

These and other objectives are achieved by a system according to claim 1.

In particular, the invention provides a positioning system for marine seismic surveying, comprising a towing vessel, a source array and a receiver array with several streamers. Each streamer comprises at least three birds and positioning sensors wherein several seismic receivers are placed between each pair of birds. The system comprises:

a) a dynamic model wherein each streamer is represented by a fitted B-spline curve and each bird is associated with a constant velocity and a constant acceleration; and
b) a Kalman filter using the dynamic model and observations from the positioning sensors to provide a geodetic position of each seismic receiver with better accuracy than the dynamic model alone and observations alone within a time interval Δt equal to or less than a minimum time between shots determined by the source array.

In any time interval Δt, most geodetic streamer positions will be displaced by a common shift provided by the Kalman filter. This is efficiently achieved by adding “large” arrays in computer memory or hardware. Deviations from a desired geodetic position and/or deviation from a desired streamer configuration in vessel-bound coordinates are rapidly identified by de Boor's algorithm applied to the B-splines. The B-splines ensure that no geodetic point outside the range of local support will be affected by recalculations.

Preferably, the system further comprises local support limited to at most four subsequent birds. This corresponds to a polynomial degree 3 or cubic B-splines. If the streamers comprise position sensors between birds, the local support is limited to 4 knot spans corresponding to 4 position sensors. In a physical system, the preferred Kalman filter corrects for unmodelled dynamics by an autocorrelation least squares (ALS) technique. Thus, the B-spline approximation of a physical streamer just has to be sufficiently accurate during one time interval Δt, i.e. for about 5 seconds.

Some of the position sensors may further provide observations of velocity and/or acceleration. Output from a MEMS-accelerometer in local rotational coordinates fall in this category. So does sea current measurements from flowmeters dispersed over the receiver array. The Kalman filter maintains precise estimates of velocities and accelerations in geodetic coordinates for use in all instances of x=vΔt+kaΔt²/2 used in the dynamic model. The Kalman filter may maintain additional parameters, e.g. sea current velocities without rapid spatial and temporal variation. An extra parameter generally means an extra degree of freedom in the Kalman filter and is a matter of design.

The observations may be expressed in geodetic and/or vessel bound coordinates. Observations in geodetic coordinates include GPS readings. Observations in vessel-bound coordinates means any measurement made relative to the towing vessel regardless of method. For example, positions obtained from known lengths of spreader cables and lead-in cables are included. So are distances provided by acoustic transducers in the receiver array and laser range measurements between the towing vessel and a reflector on a buoy.

A system involving physical source and receiver arrays needs a closed loop control system for controlling the physical components of the system. Such a control system should be capable of receiving an input vector from the Kalman filter and of presenting a response equal to the negative input vector. For example, a force is opposed by a force of equal size and opposite direction irrespective of coordinate system. The closed loop control system as such is known in the art.

The input vector to the control system may express a deviation from a desired position in geodetic coordinates. The proper response is a displacement in the opposite direction. Similarly, the response to a deviation from a desired streamer configuration expressed in vessel-bound coordinates is an opposite displacement in the input coordinates. The proper response to a force expressed in an arbitrary TNB-frame is a force of equal size and opposite direction expressed in the input coordinates. Transformations to and from other coordinates add computer cycles but does not change the result.

A transformation between any pair of coordinate systems may be performed by one matrix multiplication. The usual method is to pre-multiply augmented matrices in R³ resp. R⁴, where each augmented matrix represent an affine transformation in R² resp. R³. This minimises the execution time for a transformation and allows a designer to balance storage vs. computing power in an efficient manner.

A preferred embodiment comprises linear extrapolation of the geodetic coordinates within the time interval Δt. This requires an array of piecewise constant velocities in addition to the array of piecewise constant positions.

### BRIEF DESCRIPTION OF THE DRAWINGS

The invention will be described by way of example and reference to the accompanying drawings, in which:

FIG. 1 illustrates a system according to the invention and

FIG. 2 illustrates a general setting for a spline fit to streamers.

### DETAILED DESCRIPTION

The drawings are schematic and intended to illustrate the invention. Thus, they are not to scale, and numerous details known to one skilled in the art are omitted for clarity.

The general idea of the invention is to use a fast and effective dynamic model and Kalman filtering to improve estimates of geodetic coordinates. We distinguish between speed (scalar) and velocity (vector), and note that the velocity (speed and heading) of a towing vessel moving at 4-5 knots is approximately constant during each time interval Δt<5 s. If the local constant velocity \dot{x} is known at each geodetic position at the start of each time interval Δt, then even more precise geodetic position estimates may be extrapolated during Δt.

The notation throughout this description and the claims follow usual conventions: Vectors and matrices are in bold Latin letters with capital letters denoting matrices. Italics indicate that R³ and C(s) are not matrices. Mark notation, e.g. C′(s), is used for space derivatives and dot notation, e.g. \dot{x}, is used for time derivatives. All scalars are real.

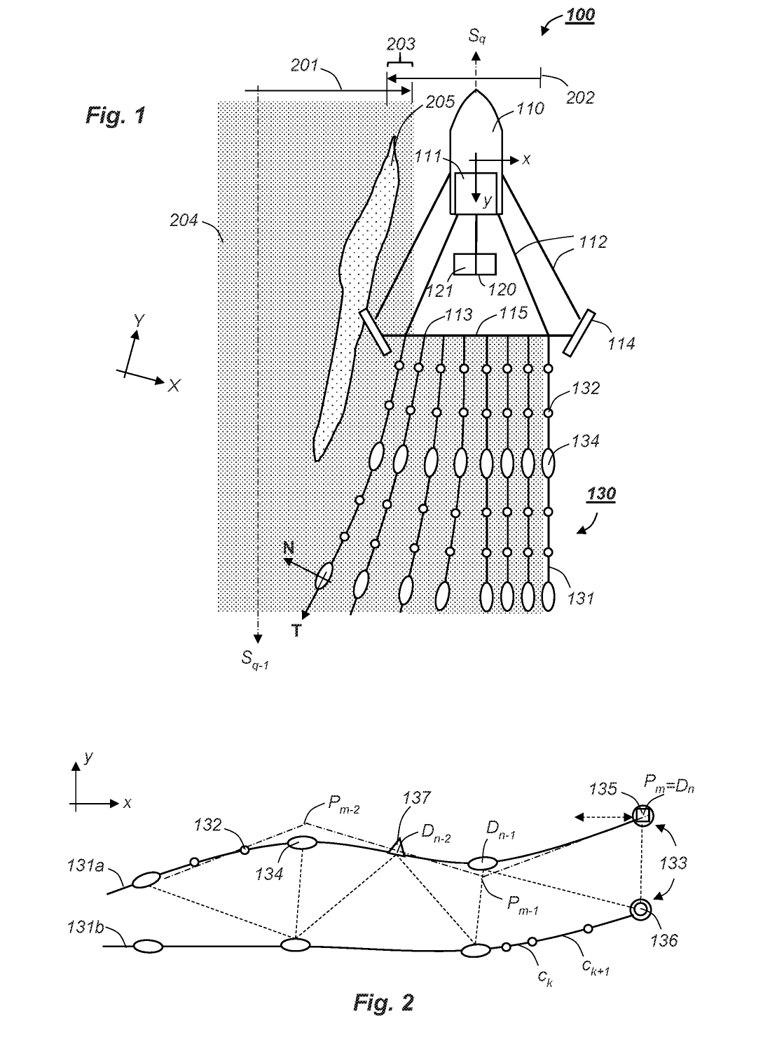

FIG. 1 illustrates a system 100 for marine seismic surveying comprising a seismic survey vessel 110 towing a source array 120 with several subarrays 121 and a receiver array 130 with several streamers 131. Arrow S_{q-1} illustrates a previous sailing line from top to bottom of the drawing and arrow 201 illustrates an area on both sides of the sailing line S_{q-1} covered by the previous pass. Similarly, arrow S_{q} illustrate a present sailing line and a towing direction in the opposite direction, i.e. from bottom to top of the drawing. Arrow 202 indicates the stripe to be covered by the present pass. According to common practice, there is a small overlap 203 between the previous and present pass. The overlap is preferably small to achieve a smallest possible survey time, yet large enough to avoid or reduce infill.

The shaded area 204 illustrates an area with adequate coverage, and the irregular area 205 within the previous pass is an area with inadequate coverage, i.e. an area needing infill. The area 205 lack coverage for some unspecified reason, and some streamers 131 are steered laterally from the present sailing line S_{q} in order to make an additional pass over the area 205.

In FIG. 1, each streamer 131 is connected to a lead-in cable 112 in a towing point 113. Paravanes 114, also known as deflectors and doors, provide a lateral force on a spreader cable 115 connected to the towing points 113 in order to maintain fixed distances between leading ends of the streamers 131. Referring to the introduction, we note that the fixed distances do not need to be equal as long as the streamers are maintained in a parallel configuration because the Langeland '156 patent belongs to free technique. However, if the spread at the tail end exceeds 5%, one may be accused for infringing on the '094 Eick patent, at least in US territorial waters. To be sure, it may be advisable to keep the leading ends at a fixed distance within 5%. No irony intended.

Several receivers 132 and birds 134 are arranged along the streamers. The birds 134 are known devices of any kind capable of imposing a lateral force on the streamer 131 and are used for steering, e.g. to compensate for lateral currents and adjust the towing depth.

A vessel-bound spatial Cartesian coordinate system x, y, z is illustrated by axes x, y with origin midship in vessel 110, y-axis parallel to and directed opposite the present sailing line or towing direction S_{q} and x-axis horizontal and perpendicular to the y-axis. The z-axis (not shown) is conveniently perpendicular to the x and y-axes in a right handed Cartesian. The direction of the y-axis on FIG. 1 illustrates that the z-axis indicates depth. A navigation system might show the y-axis pointing in the towing direction, i.e. opposite to that shown in FIG. 1. Streamer bound coordinates are expressed in right handed Cartesian coordinates tangent, normal and binormal to the streamer, commonly called a TNB-frame. Similar to the z-axis, the B-axis is not shown in FIG. 1.

The area 205 is expressed in geodetic coordinates, for example in an Earth-bound Cartesian grid (X, Y). A graphical display similar to FIG. 1 merely requires a 2D map of the area. In particular, a point between a source 121 and a receiver 132 is sufficient to indicate a reflection in a graphical view similar to FIG. 1. The density of such points may indicate coverage. Similarly, underwater currents at the towing depth in geodetic coordinates could be displayed as a field of short arrows representing sea current velocities as known in the art.

For steering physical arrays, the system 100 needs a closed loop control system. In the present context, such a control system just changes sign on an input vector. For example, the proper response to a “deviation from a desired position” in geodetic resp. local coordinates is a displacement of equal size in the opposite direction expressed in input coordinates. Similarly, the response to an input force vector would be a response vector of equal size and opposite direction expressed in arbitrary input coordinates. The control system as such is known in the art and need no further explanation herein.

The Cartesian coordinates in FIG. 1 are chosen for convenience, and may be replaced with polar, spherical or other coordinates if desired. However, according to common practice calculations should be performed in a consistent coordinate system to prevent round-off errors from adding up. For example, transforming rotational coordinates roll α, pitch β and yaw γ to Cartesian coordinates (x, y, z) involves calculating sines and cosines which introduce round-off errors. As long as calculations are performed in one system, e.g. (x, y, z), the numerical errors caused by one transformation from (α, β, γ) to (x, y, z) before calculation and another transformation back to (α, β, γ) are insignificant. Similar considerations apply to representations that involves finite differences, e.g. Hermite splines and Jacobians.

All transformations between the systems in FIG. 1 comprise a translation and a rotation, which are examples of affine transformations. Other important affine transformations are scaling, reflection and projection, e.g. from 3D to a 2D computer screen. Cartesian coordinates form affine spaces, and affine transformations by definition preserves collinearity and ratio of length. Thus, a position vector and its time derivatives velocity and accelerations in Cartesian coordinates are invariant under affine transformations. In addition, 2D and 3D B-splines are affine invariant, and may be projected on a 2D computer screen without difficulty. For example, an affine transformation of a 3D B-spline curve is equivalent to transformation of its control points. After transformation of a few control points, the curve is easily recalculated in 2D for display. The following brief overview of affine transformations in matrix notation is included for reference.

Any sequence of affine transformations can be combined to one transformation in a higher dimensional space. For example, a 3D affine transformation can be expressed as:

y(x)=Ax+b (1)

where
x is a vector in an affine domain space, e.g. the (x, y, z) coordinates in FIG. 1,
y, b are vectors in an affine codomain (target domain), e.g. (T, N, B) or (X, Y, Z) in FIG. 1 and
A is a transformation matrix, e.g. a 3×3 rotation matrix.

The affine transformation (1) can be rewritten in augmented form in 4D:

$${y}_{4} = [ \begin{matrix}{y}_{1} \\ {y}_{2} \\ {y}_{3} \\ 1\end{matrix} ] = M {x}_{4} = [ \begin{matrix}{a}_{11} & {a}_{12} & {a}_{13} & {b}_{1} \\ {a}_{21} & {a}_{22} & {a}_{23} & {b}_{2} \\ {a}_{31} & {a}_{32} & {a}_{33} & {b}_{3} \\ 0 & 0 & 0 & 1\end{matrix} ] [ \begin{matrix}{x}_{1} \\ {x}_{2} \\ {x}_{3} \\ 1\end{matrix} ] \qquad ( 2 )$$

where aᵢⱼ is a real scalar from row i and column j of the transformation matrix A.

Any sequence of affine augmented matrices can be multiplied to yield a new matrix of the same form. Moreover, M is invertible if and only if A is invertible, and is expressed by:

$${M}^{- 1} = [ \begin{matrix}{A}^{- 1} & ( - {A}^{1} b ) \\ 0 … 0 & 1\end{matrix} ] \qquad ( 3 )$$

where A⁻¹=A^{T} if A represents any rotation in R^{N}, N=2, 3, . . . . Note the similarities with and differences from a 3D decomposition of rotation, e.g. yaw, pitch and roll expressed by a composite 3D rotation matrix R=R_{z},R_{y}Rₓ.

Returning to FIG. 1, the task is to determine the geodetic position of each source and receiver in the arrays 120 and 130 to within a few metres. The position at the end of a time interval Δt can be “predicted” as x₁=x₀+vΔt where x0 is the position at the start of the interval and v is a constant velocity. If many such steps are added, truncation errors add and the “predicted” sum diverge or drift from the true position. The general idea of a Kalman filter is to compensate this drift by measurements, but not so much that the output estimates change rapidly due to uncertain observations, e.g. GPS readings. In addition, a Kalman filter includes calculated responses, e.g. a force applied through a bird 134 to oppose feathering.

The simple Kalman filter is a recursive algorithm where each time step k includes a “prediction phase” essentially comprising the calculations, and an “update phase” for collecting “observations” (sensor measurements) and computing output estimates from the step. The output estimates are weighted sums of predictions and observations, and are passed on to the next time step (k+1).

The calculations in the prediction phase depend on a dynamic model of the system. We have already approximated velocity by a constant velocity v, and note that constant acceleration does not represent a loss of generality due to the mean value theorem over the time interval Δt. Thus, a simple dynamic model of the present system is x=vΔt+aΔt²/2 with constant v and a applied to all elements in the system 100. Real embodiments may include, for example, a response to feathering forces acting on a length of the streamer. However, we know in advance that any model is imperfect: The present model includes truncation errors and round-off errors in the approximations of v and a. Best practice is to keep the dynamic model simple and leave as much as possible to “unmodelled dynamics” described below. If this approach fails, more features such as tension, curvature and/or rotational forces may be included in the dynamic model.

In the present example, only the paravanes 114, birds 134 and steerable tail buoys 133 can exert a force. In the prediction phase, all other elements are just shifted by Δx=vΔt, where v is the instantaneous towing velocity at the start of time interval Δt. Imagine that all sensor positions x in geodetic coordinates are stored in a large computer array. The positions would be stored in an ordered manner, for example as a look-up table where each row represent a streamer and element E[r, i] in row r represent the X or Y coordinate of sensor no i along streamer no. r. For numbers, 32b (4B) per dimension provides negligible round-off errors on the scale 1/20000. Using 32b numerical resolution, 50 000 geodetic positions in 2D (X, Y) would need about 400 kB of storage. Thus, several or all rows in the lookup table would fit nicely in the computer memory of an ordinary PC. Adding a constant vΔt to all elements in an array stored in fast hardware (computer memory) is handled by hardware during a few cycles in most CPUs and GPUs. Thus, we do not worry about the execution time of 10 000-30 000 additions in a loop, and remark that such straightforward parallelisation generally decreases execution times by orders of magnitude.

Next, we need a model for the streamers. The streamers are not mechanically coupled, so an appropriate dynamic model should represent each streamer as an individual curve in space. B-splines are preferred for their local support property and several other useful properties. B-splines are widely used in other fields of technology for similar reasons. For example, B-splines limit the number of pixels that must recalculated in a computer image with a moving foreground and static background.

FIG. 2 illustrates the general setting. We want to pass a smooth (C²-continuous) B-spline curve C(s) through a sequence of data points Dᵢ in (x, y, z) coordinates. Specifically, this means finding a sequence of control points Pᵢ in an enclosing polyline. Moreover, the polynomial degree of C(s) should be as low as possible for a best possible approximation of the streamer. This implies polynomials with degree j=3, i.e. cubic B-splines. The bolded notation C(s) means that the scalar parameter s generates separate curves x(s), y(s) and z(s), each of which is independent of polynomial degree. Once C(s) is found, the position of any seismic receiver 132 can be found by polynomial interpolation using de Boor's algorithm, which is known to be fast and numerically stable.

The seismic receivers 132 are commercially available devices used to sample a P-wavefield and typically contain hydrophones and/or other seismic sensors. Any suitable seismic receiver 132 may be included in a streamer 131. For later reference, we note that the tension in a 10-20 km long streamer may cause significant strain. However, the distance between two adjacent seismic receivers 132 will remain approximately constant during a survey. The two distances cₖ and c₊₁ on streamer 131b illustrate that distances between adjacent elements are approximately constant but not necessarily equal. Each inline distance cₖ is known in advance, e.g. measured during deployment.

Birds 134 and position sensors 135-137 are also included in a streamer. A bird 134 may include a position sensor, e.g. an acoustic transducer 137 for determining distances to nearby acoustic transducers 137. The dashed lines between streamers 131a and 131b in FIG. 2 illustrate distances between such acoustical transducers, not mechanical connections.

Other common position sensors shown in FIG. 2 include a reflector 135 mounted above the sea surface on a tail buoy 133 attached to the trailing end of streamer 131a. A ranging laser/interferometer system operating in the visible or infrared range determines the distance from vessel 110 to the reflector 135 as illustrated by a double-headed arrow. A laser ranging system has a limited range, so the reflector 135 might be mounted on a buoy closer to the towing vessel in an array with several km long streamers. As the reflector 135 bobs up and down and tilts back and forth due to waves on the sea surface, measurements of range and bearing will vary from one time interval to the next without a corresponding motion of the tail of streamer 131a. This is an example of “observation noise” and illustrate that a real variance in R³ may be an ellipsoid.

Streamer 131b is connected to a separate tail buoy or float 133 with a GPS antenna 136 above the sea surface. The associated data point has a different mean position and variance than those of the GPS antenna on vessel 110.

Other common and useful sensors not shown in FIG. 2 include, but are not limited to, inertial measurement units (IMUs) with MEMS-accelerometers, flow meters for measuring size and direction of underwater currents and stress or strain gauges mounted at any location where stress or strain is an issue, e.g. at the towing points 113. The skilled person is familiar with these and other suitable sensors.

The data points Dᵢ may be measured by any means. Referring to FIG. 1, the length of lead-in cables 112, positions of the paravanes 114 and known lengths in the spreader cable 115 may help to determine the towing point 113 for a streamer 131.

Only the last few data points Dₙ₋₂, Dₙ₋₁, Dₙ are shown in FIG. 2. Do is the towing point 113 at the leading end and the last point Dₙ corresponds to the tail end of the streamer. The sequence of data points Dᵢ defines n curve segments Cᵢ(s)∈[Dᵢ₋₁, Dᵢ>; 1<i<n. C²-continuity means that the curve C(s) is required to be continuous and have continuous first and second derivatives C′(s), C″(s) at each data point Dᵢ.

In the following, we will use some generally known properties and formulas. An overview can be found online, e.g. in “B-spline curves: Important properties” [1] or Wikipedia.

For our fit, we require that P₀=D₀ and that Pₘ=Dₙ. For a cubic B-spline, this implies that m=n+2. The parameter value sᵢ that corresponds to the joint at Dᵢ is called a knot, and the sequence of knots in ascending order is called the knot vector. According to common practice, the knot vector is normalised to [0, 1] to improve numerical stability due to the relatively high density of floating numbers in this interval. Referring to FIG. 2, a cumulative chord length parameterization seems reasonable. In recursive form:

$${s}_{0} = 0 \\ {s}_{k} = {s}_{k - 1} + \frac{{c}_{k}}{{L}_{tot}} , 1 \leq k \leq n ; \qquad ( 4 )$$

where
cₖ is a constant length between two adjacent sensors 132-137 on the streamer
Lₜₒₜ is the total length of the streamer—a measured value if strain is significant, and
n is the number of sensors 132-137 on the streamer

Note that this knot vector contains values sₖ for all sensors, while the curve fitting needs a much smaller knot vector with knots sᵢ for the positioning sensors. Knot vectors representing sₖ resp. sᵢ may conveniently be stored as rows in a look-up table similar to that for geodetic positions described above.

In order to clamp a B-spline of degree j to control points at its end, i.e. ensure that D₀=P₀ and Dₙ=Pₘ=Pₙ₊₂, the first and last j+1 knots are repeated. Thus, for a cubic B-spline clamped at both ends s₀=s₁=s₂=s₃=0 and sₙ=sₙ₊₁=sₙ₊₂=sₙ₊₃=1 in the sᵢ-knot vector.

The B-spline curve has the form

$$C ( s ) = {\sum }_{i = 0}^{n} {P}_{i} {N}_{i , j} ( s ) , s ∈ [ 0 , 1 ] \qquad ( 5 )$$

where N_{i,j}(s) are B-spline basis functions defined by Cox-de Boor's recursion formula:

$$\begin{matrix}{N}_{i , 0} ( s ) = 1 if {s}_{i} \leq s < {s}_{i + 1} and 0 otherwise & ( 6 a ) \\ {N}_{i , j} ( s ) = \frac{s - {s}_{i}}{{s}_{i + j} - {s}_{i}} {N}_{i , j - 1} ( s ) + \frac{{s}_{i + j + 1} - s}{{s}_{i + j + 1} - {s}_{i + 1}} {N}_{i + 1 , j - 1} ( s ) & ( 6 b )\end{matrix}$$

We do not assume that all knot spans are equal, so a closed form of (6a, 6b) would look complicated. More important, the recursive expressions (6a), (6b) execute faster than closed form expressions would. Due to the step function in (6a), the first term in No(s) is nonzero only on knot span i, and the second term is nonzero only on knot span i+1. Each subsequent iteration of (6b) adds a knot span until 4 knot spans are added for j=3. This is the local support mentioned above.

In the case of cubic splines, at most 3 curve intervals Cᵢ(s) are valid on any knot Sᵢ, so the fitting criterion is of the form:

N_{i,3}(sᵢ)Pᵢ+N_{i+2,3}(sᵢ)Pᵢ₊₂=Dᵢ (7)

Now, P₀=D₀ and Pₙ₊₂=Dₙ so equation (7) yields n−1 independent equations in n+1 unknowns. We need two extra conditions for a unique solution, and set the second derivatives to zero at the ends, i.e. C″(0)=0 and C″(1)=0. This seems reasonable in view of the streamer to be modelled.

We need expressions for the spatial derivatives for later reference:

$$\begin{matrix}{C}^{′} ( s ) = \frac{dC ( s )}{ds} = {\sum }_{i = 0}^{n - 1} {N}_{i , 2} ( s ) {Q}_{i} ; {Q}_{i} = \frac{3}{{s}_{i + 4} - {s}_{i + 1}} ( {P}_{i + 1} - {P}_{i} ) & ( 8 ) \\ {C}^{″} ( s ) = \frac{{d}^{2} C ( s )}{{ds}^{2}} = {\sum }_{i = 0}^{n - 2} {N}_{i , 1} ( s ) {R}_{i} ; {R}_{i} = \frac{6 ( {P}_{i + 1} - {P}_{i} )}{( {s}_{i + 4} - {s}_{i + 1} ) ( {s}_{i + 3} - {s}_{i + 1} )} & ( 9 )\end{matrix}$$

where
the knot vector for (8) is the original with one copy of so and one copy of sₙ removed and
the knot vector for (9) is the original with second copies of so and sₙ removed.

In our curve fitting of a cubic spline, we have s=s₀=s₁=0 corresponding to P₀=D₀ in (x, y, z) Similarly, Pₙ₊₂=Dₙ correspond to sₙ=sₙ₊₁=sₙ₊₂=1. Thus, the first and last three terms of (9) yields a₁P₁+a₂P₂=D₀ and aₙPₙ+aₙ₊₁Pₙ₊₁=Dₙ by simple algebra. Together with (7), these yield a system with n+1 equations in n+1 variables:

$$A [ \begin{matrix}{P}_{1} \\ {P}_{2} \\ ⋮ \\ {P}_{n + 1}\end{matrix} ] = [ \begin{matrix}{D}_{0} \\ {D}_{1} \\ ⋮ \\ {D}_{n}\end{matrix} ] \qquad ( 10 )$$

where A is a banded matrix with at most 3 non-zero elements per row.

Standard methods for solving (10) without numerically expensive inversion include LU-decomposition and QR-decomposition with forward substitution. In a variant of forward substitution, we could solve the upper left 3×3 matrix of A and compute each next control point Pᵢ from the previous 3 control points and the next Dᵢ.

The system (7) corresponds to a “fat” matrix, i.e. a matrix with more columns than rows (m>n), and the second derivatives need not be zero. In practice, minimal norms are widely used to provide the missing equations for a fat matrix system. For example, a least squares fit (minimal L₂ norm) is appropriate in many applications. For B-splines, a minimal polyline (minimal L₁ norm) might be an alternative due to the “strong convex hull property” of B-splines. In general, the QR decomposition involves an n×n matrix Rᵢ padded with zeros in the last m-n rows. Another useful concept for numerical applications is “pseudo inverse matrices” A^{†} which are sufficiently inverse to make A^{†}A≈I. More precisely, a typical pseudo inverse matrix is computed by a recursion that stops when a residual is below some limit, for example a predefined tolerance of a few metres or a limit due to truncation or round-off errors. These and other algorithms from numerical linear algebra are available in software libraries and need no further explanation here.

The sₖ for any sensor 132-137 is found from a lookup table, cf eq. (4). C(sₖ) and de Boor's algorithm yields the position of the sensor in vessel-bound coordinates (x, y, z).

Next, we need a TNB-frame for birds 134, flow meters measuring sea current etc. The original Frenet-Serret formulas regard the kinematics of a particle moving along a continuous and differentiable parametric curve in R³ and define a TNB-frame with Cartesian unit vectors tangent, normal and binormal to the parametric curve. They are valid for any real scalar parameter s, not just the special case in equation (4). Again, we only need a few general results, and refer to textbooks or online articles for a thorough description.

Noting that C′(s) is tangent to C(s), we express the TNB-frame in matrix notation:

$$\begin{matrix}T ( \overline{s} ) = [ \begin{matrix}{T}_{x} ( \overline{s} ) \\ {T}_{x} ( \overline{s} ) \\ {T}_{z} ( \overline{s} )\end{matrix} ] = \frac{{C}^{′} ( \overline{s} )}{‖ {C}^{′} ( \overline{s} ) ‖} & ( 11 ) \\ N ( \overline{s} ) = [ \begin{matrix}{N}_{x} ( \overline{s} ) \\ {N}_{y} ( \overline{s} ) \\ {N}_{z} ( \overline{s} )\end{matrix} ] = \frac{{C}^{′} ( \overline{s} ) \times [ {C}^{″} ( \overline{s} ) \times {C}^{′} ( \overline{s} ) ]}{‖ {C}^{′} ( \overline{s} ) ‖ ‖ {C}^{″} ( \overline{s} ) \times {C}^{′} ( \overline{s} ) ‖} & ( 12 ) \\ B ( \overline{s} ) = T \times N & ( 13 )\end{matrix}$$

where ∥C∥=\sqrt{Cₓ²+C_{y}²+C_{z}²} is the Euclidian norm, and a cross product in matrix form is

$$c = a \times b = [ \begin{matrix}{c}_{x} \\ {c}_{y} \\ {c}_{z}\end{matrix} ] = [ \begin{matrix}{a}_{2} {b}_{3} - {a}_{3} {b}_{2} \\ {a}_{3} {b}_{1} - {a}_{1} {b}_{3} \\ {a}_{1} {b}_{2} - {a}_{2} {b}_{1}\end{matrix} ] ; \\ a = [ {a}_{x} , {a}_{y} , {a}_{z} ] , b = [ {b}_{x} , {b}_{y} , {b}_{z} ] \qquad ( 14 )$$

A unit normal is undefined for a “straight line” and need special consideration: Let Dᵢ₋₁, Dᵢ, Dᵢ₊₁ be corners in a triangle. If the height of the triangle is greater than a specified tolerance, compute N and B at Dᵢ from (12) and (13). Otherwise, set the values for N and B equal to those of Dᵢ₋₁. Here, the maximum height of the triangle corresponds to half the tolerance specified for the (x, y, z) positions Dᵢ.

T and N are shown in FIG. 2. In right-handed coordinates, B would point downward or into the paper plane in FIG. 2 which is the preferred direction for seismic surveying applications. C′(s̅) is efficiently calculated by de Boor's algorithm using the B-spline in equation (9). C′(s̅) and its Euclidian norm from eq. (11) are reused in eq. (12). Similarly, de Boor's algorithm on the B-spline in eq. (9) yields C″(s̅).

Derivation with respect to time does not change the direction of a vector, so measurements of position, orientation, velocity and acceleration in a TNB-frame can be transformed to any coordinates of choice using eq. (2) and pre-multiplication.

The model of streamers described so far may be enhanced by fitting B-splines in the crossline direction and/or by defining a polygonal, e.g. triangular, mesh over acoustic transducers 137. Spline fitting in 1D and 2D is available in readymade software, e.g. graphics libraries. Some 2D splines, e.g. thin plate splines, assume elastic properties in two spatial directions and are inappropriate for decoupled streamers.

Assume the framework above is used to define a desired streamer configuration in a GUI and that the computer model provides a list of desired data points dᵢ. The Kalman filter maintains a similar list of estimated data points Dᵢ. Both lists are in vessel-bound coordinates (x, y, z) and are thus independent of towing velocity and associated time shifts in geodetic coordinates. In each time interval Δt, changing sign on Dᵢ and adding to dᵢ yields a tentative response. As above, operations can be performed on entire “rows” in computer memory. All elements in the tentative response array smaller than a predefined constant tolerance are ignored, those remaining are proper responses to a deviation.

For each such deviation, equation (7) defines 3 control points that must be recomputed to fit the cubic B-spline C(s) through the deviant Dᵢ. No other part of the B-spline is affected due to the local support property. Thus, the curve fitting means solving a 3×3 system with known coefficients. QR-decomposition with forward substitution is effective also in the rare cases where several adjacent data points are out of line within Δt.

Once the three control points are recomputed, all sensor positions on the 4 affected knot spans must be recomputed using de Boor's algorithm on a sequence from the sₖ knot vector. The results are transformed to geodetic coordinates and replace elements in the geodetic lookup table. A few of these elements, e.g. birds 134 and flow meters may need additional computation for a new TNB-frame.

A GUI may conveniently have a “local view” for streamer configuration etc. in vessel-bound coordinates and a “geodetic view” for showing “common midpoints” and sea current fields in geodetic coordinates as described above. B-splines are affine invariant, so a graphics engine, i.e. graphics software and a graphics card, just need a few control points to display the curve. In addition, any such graphics engine combine affine transformations and thus enable zooming in on any part of the streamer array and viewing the section or the entire streamer array in perspective and from any angle in real time. The required input is just a few control points in vessel-bound coordinates. The local sea current may be displayed as a nicely coloured graded background. For this, the graphics engine typically uses Bézier curves, which are B-splines without knots between the clamping zeros at the start and end of the knot vector.

The Kalman filter may have several external degrees of freedom such as the geodetic and vessel-bonds positions above. The number of internal states and variables is a matter of design. In the following, we use a bird 134 as example, and add velocity and acceleration as internal states. Using the notation above and dot notation for time derivatives, we let:

$${x}_{k} = [ \begin{matrix}x \\ \dot{x} \\ \ddot{x}\end{matrix} ] \\ {F}_{k} = [ \begin{matrix}1 & Δ t & \frac{Δ t}{2} \\ 0 & 1 & Δ t \\ 0 & 0 & 1\end{matrix} ] … {B}_{k} = [ \begin{matrix}{b}_{11} & {b}_{12} & {b}_{13} \\ {b}_{21} & {b}_{22} & {b}_{23} \\ {b}_{31} & {b}_{32} & {b}_{33}\end{matrix} ] … {u}_{k} = [ \begin{matrix}0 \\ 0 \\ ca\end{matrix} ] \qquad ( 15 )$$

where x is in geodetic coordinates and B transforms from the bird's TNB-frame.

Let index min denote the state up to and including n. The prediction phase estimates a preliminary (a priori) state in step k from the output (a posteriori) estimates in step (k−1):

x̅_{k|k-1}=Fₖ\hat{x}_{k-1|k-1}+Bₖuₖ P_{k|k-1}=FₖP_{k-1|k-1}Fₖ^{T}+Qₖ (16)

Fₖ is the “state transition model” that brings the filter from step (k−1).

Bₖ is a “control model” and uₖ a “control vector” that express the response calculated for step k, e.g. based on an estimated local current and properties of the bird. The resulting force is transformed first to ka in vessel-bound coordinates, then to the relevant TNB-frame by ca=B⁻¹ ka. The two transformations are combined into one matrix multiplications by eq. (2). Paravanes, steerable tail buoys and other equipment that can apply a force have Bu-terms, whereas seismic receivers 132, acoustic transducers 137 etc. lack the Bu term.

The P's are “prediction error covariance matrices” defined by recursion. If little or nothing is known in advance, a common assumption is random walk leading to P_{0|0}=Iσ², where I is the identity matrix and the system variance σ² some scalar, e.g. 0.5. A properly designed filter converges, so the effort spent on estimating optimal values should be limited. The present KF will have performed 120 five second steps in ten minutes.

Q is the covariance of process noise wₖ˜N(0, Q). The process noise may contain unmodelled dynamics and other systematic faults that may cause the filter to diverge and that are difficult to distinguish from observation noise. Common practice is to compute the covariance matrix Q by statistical methods, e.g. an ALS technique. ALS is an acronym for auto-covariance least-squares and essentially uses data from several previous steps to look for systematic deviations. A comprehensive description can be found online or in the literature.

The update phase regards measurements, weighted sums and the output state. A first task is to find an “observation residual” from present and previous measurements:

\tilde{y}ₖ=zₖ−Hₖ\hat{x}_{k|k-1} (17)

The “observation vector” zₖ for a specific bird correspond to a data point Dᵢ in FIG. 2. However, the Dᵢ's were expressed in (x, y, z), whereas x and z are expressed in (X, Y). The “observation model” H simply picks previous estimates. For example, H=[1 0 0] picks a position estimate corresponding to a Dᵢ for a bird 134 or an acoustic transducer 137. If the bird also provides a velocity measurement, e.g. representing sea current, H would have an additional 1 in the velocity position, i.e. H=[1 1 0]. In an alternative version of the KF, the measurements from acoustic transducers 137 could be treated as a fourth degree of freedom and be picked by H=[0 0 0 1].

We also need a “residual covariance” Sₖ=HₖP_{k|k-1}Hₖ^{T}+Rₖ, where R is the covariance of observation noise and usually approximated by ALS.

The “optimal Kalman gain” Kₖ=P_{k|k-1}Hₖ^{T}Sₖ⁻¹ is optimal in the sense that it minimises the least square difference between x and its estimate \hat{x}. Its elements are real scalars in the interval [0, 1]. The expressions for S and K may look complicated, but are easily implemented because H simply picks a previous variable as described above.

The output state or a posteriori estimates in step k are

\hat{x}_{k|k}=\hat{x}_{k|k-1}+Kₖ\tilde{y}ₖ P_{k|k}=(I−KₖHₖ)P_{k|k-1} (18)

“Large” elements Kij in the Kalman gain Kₖ, i.e. values in the interval <0.5, 1], puts more weight on observations and decrease the weight on prediction accordingly. The weighted sums in (18) are the values input to the next step (k+1).

In real embodiments, simple Kalman filters are numerically unstable if the values in the covariance matrices become small. The reason is that the covariance matrices P, Q, R by definition are positive definite, but small elements may cause negative round-off errors that render the matrices indefinite. The standard solution is to represent P, Q, R in square root form, preferably as UD-decompositions. Efficient algorithms for the Kalman prediction and update phases in square root form can be found in Thornton [2] and Bierman (1977) [3].

Adding velocity to the previous example with geodetic positions, the a posteriori position and velocity estimates from step (k−1) can be used to extrapolate positions during step k. For a towing speed 2.6 m/s (5 knots), this linear approximation would improve geodetic estimates by about 1.3 m compared to the position output from step (k−1). In a 2D-grid (X, Y) this extra degree of freedom would require an extra 400 kB of storage using the numbers above. Of course, the storage need will be different in a real embodiment.

During a turn between sailing lines S_{q-1}, S_{q} streamers are “thrown out” or separated to minimise operational cost and the risk for tangling. The shapes of the leftmost streamers in FIG. 1 resembles their shapes during such a throw out. A Kalman filter providing accurate position estimates reduces a need for safety margins due to uncertain position measurements. If velocity were added as a degree of freedom to such a KF, it would be possible to compare accurate crossline velocities to predetermined values optimised to minimise turning time. The added degrees of freedom would increase storage requirements, but the added processing power would only be marginally raised due to the local support property of B-splines.

The B-splines curves are expected to approximate physical streamers sufficiently well. Referring to FIG. 1, even during a right turn with maximum crossline speed at the tail buoy of the leftmost streamer, bird no. 3 from the end is unlikely to move much in Δt˜5 s.

The Kalman filter as such is cheap on storage and processing power. ALS techniques calculate autocorrelation on a series of previous estimates and are costlier. However, a rough estimate of a MB per degree of freedom and time lags of ˜1000 steps yield storage needs in the GB range. Thus, an inexpensive PC-class computer running reasonably effective common operating and filesystems, e.g. some Linux dialect with ext4, should be able to run the proposed KF in real-time. Alternatively, a lightweight real-time operating system installed on the PC-class computer would remove further dead cycles. A specialised file system may improve mapping from filesystem to memory compared to general purpose filesystems.

The above and other embodiments are within the scope of the present invention. The skilled person will recognize these and other applications and modifications of the invention defined in the appended claims.

### REFERENCES

[1] http://www.cs.mtu.edu/˜shene/COURSES/cs3621/NOTES/spline/B-spline/bspline-curve-prop.html
[2] Thornton, Catherine L: “Triangular Covariance Factorizations for Kalman Filtering” (PhD thesis), Nasa Technical Memorandum 33-798, 1976
[3] Bierman, G. J: “Factorization Methods for Discrete Sequential Estimation”, Academic Press, 1977

1-10. (canceled)

11. A positioning system for marine seismic surveying, comprising:
a towing vessel;
a source array; and
a receiver array with several streamers, each streamer comprising at least three birds and positioning sensors, wherein several seismic receivers are placed between each pair of birds, wherein
a) a dynamic model wherein each streamer is represented by a fitted B-spline curve and each bird is associated with a constant velocity and a constant acceleration; and
b) a Kalman filter using the dynamic model and observations from the positioning sensors to provide a geodetic position of each seismic receiver with better accuracy than the dynamic model alone and observations alone within a time interval Δt equal to or less than a minimum time between shots determined by the source array.

12. The system according to claim 11, further comprising local support limited to at most four subsequent birds such that a change imposed anywhere in the receiver array affect no element in the system outside this range.

13. The system according to claim 11, wherein a position sensor further provides observations of velocity and/or acceleration.

14. The system according to claim 11, wherein the observations are expressed in geodetic (X, Y) and/or vessel bound (x, y, z) coordinates.

15. The system according to claim 11, further comprising a closed loop control system for controlling the physical components of the system, capable of receiving input from the Kalman filter and of changing sign on an input vector and presenting the resulting vector as response.

16. The system according to claim 15, wherein the input vector expresses a deviation from a desired position in geodetic coordinates (X, Y).

17. The system according to claim 15, wherein the input vector expresses a deviation from a desired streamer configuration in vessel bound coordinates (x, y, z).

18. The system according to claim 15, wherein the input vector is expressed in a tangent-normal-binormal frame local to a bird and/or positioning sensor.

19. The system according to claim 11, wherein a transformation between any pair of coordinate systems is performed by one matrix multiplication.

20. The system according to claim 11, further comprising linear extrapolation of the geodetic coordinates within the time interval Δt.
